(19) United States
(12) Patent Application Publication
(10) Pub. No.: US 2002/0150055 A1
(43) Pub. Date: Oct. 17, 2002

(54) Topology correction method and communication node

(75) Inventor: Toshihiro Tatsumi, Osaka (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/001,968

(22) Filed: Dec. 5, 2001

(30) Foreign Application Priority Data
Apr. 13, 2001 (JP) 2001-115202

(51) Int. Cl. H04L 12/28; H04L 12/26; H04J 3/14; G06F 11/00

(52) U.S. Cl. 370/255; 709/221

(57) ABSTRACT

In a network including a plurality of communication nodes, communication is allowed to continue even when annular connection is generated. When a new transmission path is added, at least one of communication nodes located at both ends of the added transmission path transmits a confirmation signal through the added transmission path, and determines whether or not a new annular path is formed by determining whether or not the transmitted confirmation signal returns from another transmission port of the communication node. When it is determined that a new annular path is formed, at least one of the communication nodes located at both ends of the added transmission path logically or physically makes the added transmission path unavailable in order to prevent formation of the annular path.

### BACKGROUND OF THE INVENTION

The present invention generally relates to a network including a plurality of communication nodes. More particularly, the present invention relates to technology of automatically correcting logical configuration of topology in an interface that is incapable of communication when communication nodes are connected in an annular manner, thereby allowing communication to continue.

In general, when the communication nodes are connected in an annular manner on the network, a plurality of data transmission paths are generated between the communication nodes, making the network immune to failure of the transmission paths. However, such annular connection may possibly cause the same data to be transmitted through a plurality of different paths or may cause the same data to be endlessly propagated through the transmission paths.

For example, in the network having annular connection by 10BASE-T defined in IEEE802.3, the transmission paths are managed as follows: a switch determines a path for data transmission from the destination of the data in order to prevent unnecessary propagation of the data.

For example, in the LAN-to-LAN (local area network) connection, the spanning tree protocol defined in IEEE802.1 or the like is used to manage and operate the transmission paths so that the transmission paths can always be used as a tree structure even in the annular network topology.

The above related art requires a network manager such as host or switch in order to conduct management of the data transmission paths, management of the network topology, and address allocation.

Accordingly, the above related art is not applicable to an interface defined by, e.g., IEEE1394, that is, an interface in which every transmission node is equal and communication must be conducted even without the host. Accordingly, in IEEE1394, annular connection makes every communication node incapable of communication.

Moreover, in IEEE1394, a large number of communication nodes (at most 63) are connectable and a large number of ports (ports where a communication cable is connected) (at most 16) are allocated to each communication node. This makes it impossible to obtain information on the source of annular connection (i.e., which transmission path of which communication node causes annular connection) from a bus. Accordingly, provided that there are only a small number of communication nodes, the user can find annular connection and correct a transmission path (remove a cable) if he/she erroneously connects the communication nodes in an annular manner. However, in view of the case where the transmission paths are connected across a plurality of rooms or 1,000 or more transmission paths are connected, it is extremely difficult for the user to find every annular path for correction.

### SUMMARY OF THE INVENTION

It is an object of the present invention to allow communication to continue even when annular connection is generated in a network including a plurality of communication nodes.

The present invention is made in view of the fact that “no annular connection exists until right before annular connection is conducted”, that is, “when annular connection is conducted, canceling only the annular connection would generate-no annular connection”.

More specifically, in the present invention, when a new transmission path is added in a network by, e.g., insertion of a communication cable or power-on of a communication node, only the communication nodes located at both ends of the added transmission path determine whether or not a new annular path is formed by the added transmission path. If a new annular path is formed, the added transmission path is logically or physically made unavailable in order to prevent formation of the annular path.

In contrast, when an arbitrary transmission path is disconnected due to, e.g., failure of a communication cable or power-off of a communication node, whether or not a logically or physically unavailable transmission path forms a part of an annular path is reconfirmed. If the transmission path no longer forms a part of the annular path, the transmission path is made available, allowing communication to continue by using the maximum available transmission paths.

More specifically, according to the present invention, a method for correcting topology in a network including a plurality of communication nodes includes: an annular-path determination process in which, when a new transmission path is added, at least one of communication nodes located at both ends of the added transmission path determines as a determining node whether or not a new annular path is formed by the added transmission path; and a transmission-path disconnection process in which, when it is determined in the annular-path determination process that a new annular path is formed, at least one of the communication nodes located at both ends of the added transmission path logically or physically makes the added transmission path unavailable in order to prevent formation of the annular path.

According to the present invention, when a new transmission path is added, at least one of communication nodes located at both ends of the added transmission path determines whether or not a new annular path is formed by the added transmission path. If it is determined that a new annular path is formed, the added transmission path is logically or physically made unavailable in order to prevent formation of the annular path. This enables even an interface that is incapable of communication when the communication nodes are connected in an annular manner to deal with the annular connection, that is, to continue communication even after the annular connection.

In the method of the present invention, the determining node is one of the communication nodes located at both ends of the added transmission path. This enables reduction in processing time for confirming whether an annular path is formed or not.

In the method of the present invention, when a new transmission path is added by turning on power of a single communication node, only the powered-on communication node serves as the determining node in the annular-path determination process. This prevents the number of communication nodes to determine annular connection from being unnecessarily increased, enabling the transmission-path disconnection process to be accurately conducted with high efficiency.

In the annular-path determination process in the method of the present invention, the determining node transmits a confirmation signal through the added transmission path, and determines whether or not a new annular path is formed by determining whether or not the confirmation signal returns from a transmission path of the determining node other than the added transmission path. This enables whether an annular path is formed or not to be determined highly efficiently and easily without specifically requiring an equipment having special capability such as host equipment. Moreover, the communication nodes have preset, unique waiting times different from each other. In the annular-path determination process, the determining node transmits the confirmation signal after the corresponding preset waiting time.

In the method of the present invention, the transmission-path disconnection process includes the step of logically or physically making an attribute of a port forming the added transmission path unavailable by one of the communication nodes located at both ends of the added transmission path.

According to the present invention, a method for correcting topology in a network including a plurality of communication nodes includes: an annular-path determination process in which, when an arbitrary transmission path is eliminated, at least one of communication nodes located at both ends of a logically or physically unavailable transmission path determines as a determining node whether or not an annular path is formed if the unavailable transmission path becomes available; and a transmission-path restoration process in which, when it is determined in the annular-path determination process that no annular path is formed, at least one of the communication nodes located at both ends of the unavailable transmission path makes the unavailable transmission path available.

According to the present invention, when an arbitrary transmission path is eliminated, at least one of communication nodes located at both ends of an unavailable transmission path determines whether or not an annular path is formed if the unavailable transmission path becomes available. If it is determined that no annular path is formed, the unavailable transmission path is made available. This allows communication to continue by using the maximum available transmission paths in an interface that is incapable of communication when the communication nodes are connected in an annular manner.

In the annular-path determination process in the method of the present invention, the determining node transmits a confirmation signal through the unavailable transmission path, and determines whether or not an annular path is formed by determining whether or not the confirmation signal returns from a transmission path of the determining node other than the unavailable transmission path. This enables whether an annular path is formed or not to be determined highly efficiently and easily without specifically requiring an equipment having special capability such as host equipment.

Moreover, the communication nodes have preset, unique waiting times different from each other. In the annular-path determination process, the determining node transmits the confirmation signal after the corresponding preset waiting time. Thus, in the case where a plurality of communication nodes transmit a confirmation signal, each communication node transmits a confirmation signal after the respective unique waiting time, so that each communication node starts the processing at different timing. This eliminates the possibility of restoring an unwanted transmission path.

In a communication node forming a network according to the present invention, when a new transmission path is added to a port of the communication node, the communication node transmits a confirmation signal through the added transmission path, and determines whether or not a new annular path is formed in the network by determining whether or not the confirmation signal returns from a transmission path of the communication node other than the added transmission path.

In a communication node forming a network according to the present invention, when an arbitrary transmission path in the network is eliminated and a port of the communication node is connected to a logically or physically unavailable transmission path, the communication node transmits a confirmation signal through the unavailable transmission path, and determines whether or not an annular path is formed if the unavailable transmission path becomes available by determining whether or not the confirmation signal returns from a transmission path of the communication node other than the unavailable transmission path.

### BRIEF DESCRIPTION OF THE DRAWINGS

FIG. 1 conceptually shows a network including a plurality of communication nodes;

FIG. 2 is a flowchart illustrating the processing in the case where a new transmission path is added according to first and second embodiments of the present invention;

FIG. 3 shows the state in which a confirmation signal is transmitted from a communication node ND4 in the network of FIG. 1;

FIG. 4 shows the state in which the confirmation signal is propagated and returns from a port P8 as a result of FIG. 3;

FIG. 5 shows the steady state after a transmission path P4-P9 is connected as a result of FIG. 4;

FIGS. 6A and 6B are conceptual diagrams of the time required for a confirmation process;

FIG. 7 shows the state in which the power of a communication node ND2 is off in the network of FIG. 1;

FIG. 8 shows an example in which a plurality of communication nodes serve as nodes to transmit a confirmation signal;

FIG. 9 shows the state in which the plurality of communication nodes to transmit a confirmation signal simultaneously transmit a confirmation signal;

FIG. 10 shows the state in which an annular path is formed as a result of simultaneous transmission of a confirmation signal;

FIG. 11 shows an example in which the plurality of communication nodes sequentially transmit a confirmation signal;

FIG. 12 shows the state in which only a powered-on communication node ND2 is determined as a node to transmit a confirmation signal, based on the state of FIG. 7;

FIG. 13 shows the state in which a confirmation signal is transmitted from a port P2 of the communication node ND2;

FIG. 14 shows the state in which a confirmation signal is transmitted from a port P3 of the communication node ND2;

FIG. 15 shows the state in which a confirmation signal is transmitted from a port P4 of the communication node ND2;

FIG. 16 shows corrected bus topology according to the second embodiment of the present invention;

FIG. 17 is a flowchart illustrating the processing in the case where a transmission path is eliminated according to a third embodiment of the present invention;

FIG. 18 shows the state in which a confirmation signal is transmitted from the communication node ND2 when a transmission path P10-P11 is disconnected;

FIG. 19 shows bus topology corrected after the transmission path P10-P11 is disconnected;

FIG. 20 shows the state in which a confirmation signal is transmitted from the communication node ND2 when the power of a communication node ND3 is shut off in FIG. 19; and

FIG. 21 shows bus topology corrected after the power of the communication node ND3 is shut off.

### DETAILED DESCRIPTION OF THE INVENTION

Hereinafter, embodiments of the present invention will be described in conjunction with the accompanying drawings. It is herein assumed that the present invention is implemented in a cable physical layer defined in IEEE1394. The embodiments will be described in view of the limitations of IEEE1394.

(First Embodiment)

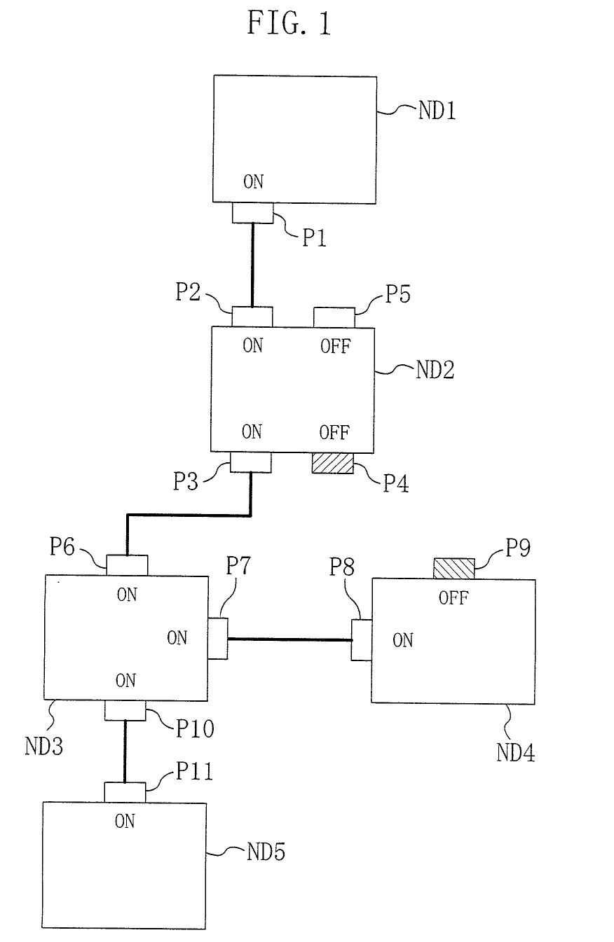

In the first embodiment of the present invention, the process of topology correction in a network including a plurality of communication nodes will be described in connection with FIGS. 1 to 6B. It is herein assumed that a new transmission path is added by cable insertion.

FIG. 1 conceptually shows a network including five communication nodes ND1 to ND5. In FIG. 1, the communication node ND1 includes a port P1. Similarly, the communication node ND2 includes ports P2 to P5, and the communication node ND3 includes ports P6, P7, P10. The communication node ND4 includes ports P8, P9, and the communication node ND5 includes a port Pll.

Note that the term “communication node” conceptually indicates an equipment forming a network. For example, provided that the network is a home LAN, the communication node corresponds to a personal computer, television, video equipment, printer or the like. The term “port” corresponds to a cable port provided in each communication node. It should be noted that the “communication node” sometimes indicates a part of a network equipment that is responsible for communication, for example, communication LSI (large scale integration) itself. In the specification, a communication node is sometimes simply referred to as “node”.

In FIG. 1, the ports P1 and P2, ports P3 and P6, ports P7 and P8, and ports P10 and P11 are connected through a corresponding communication cable. Hereinafter, a transmission path connecting ports A and B is referred to as “transmission path A-B”. More specifically, in the network of FIG. 1, transmission paths P1-P2, P3-P6, P7-P8 and P10-P11 have already been formed.

Description will now be given for the processing in the case where the ports P4 and P9 are connected through a cable, that is, in the case where a new transmission path P4-P9 is added.

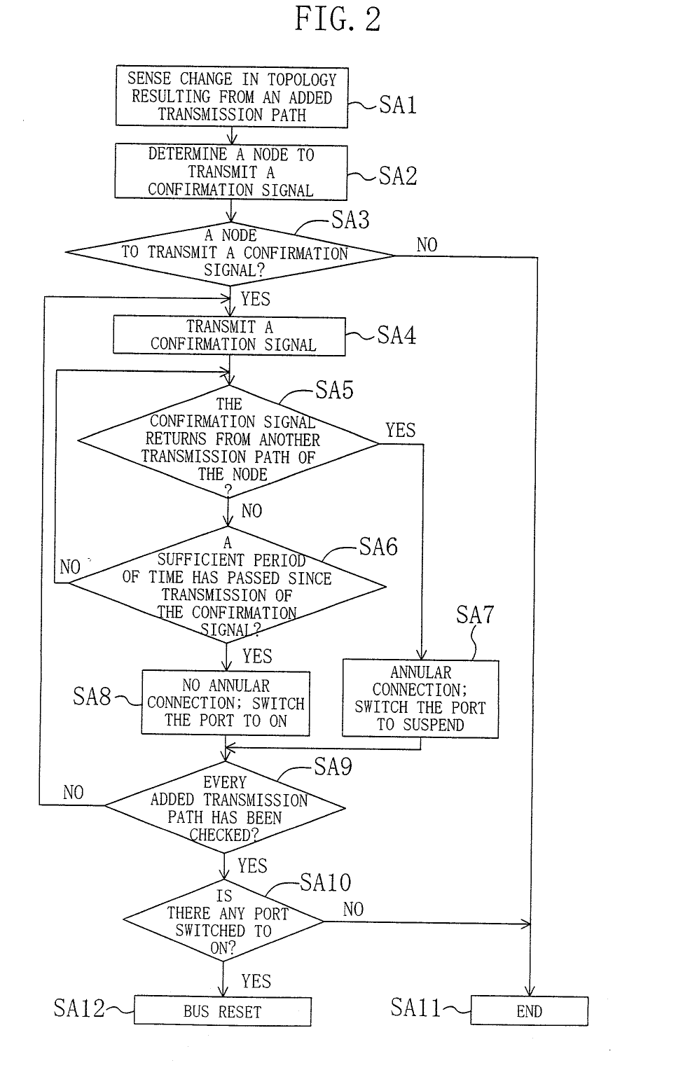

FIG. 2 is a flowchart illustrating the processing conducted by the equipments detecting an added transmission path, that is, the equipments located at both ends of the added transmission path. It is herein assumed that the transmission path is added by turning on the power of a communication node, connecting communication nodes or the like. Note that, during the processing of FIG. 2, a port recognizing the new transmission path transitions from OFF state to TEST state. Steps SA4 to SA6 correspond to an annular-path determination process, and step SA7 corresponds to a transmission-path disconnection process.

First, the communication nodes ND2, ND4 sense change in topology resulting from the added transmission path (step SA1). Only these communication nodes ND2, ND4 conduct the subsequent processing.

Then, a communication node to conduct a confirmation process is determined (step SA2). The communication node to conduct the confirmation process is herein determined by a method for determining the parent-child relation between the ports defined by IEEE1394. More specifically, in the case of FIG. 1, the parent-child relation between the ports P4 and P9 is determined by transmitting PARENT_NOTIFY, CHILD_NOTIFY signals between the ports P4 and P9, and a communication node having a parent port is determined as a communication node to transmit a confirmation signal.

It is herein assumed that the port P9 is a parent port and thus the communication node ND4 transmits a confirmation signal. In other words, only the communication node ND4 as a determining node conducts the subsequent processing (step SA3).

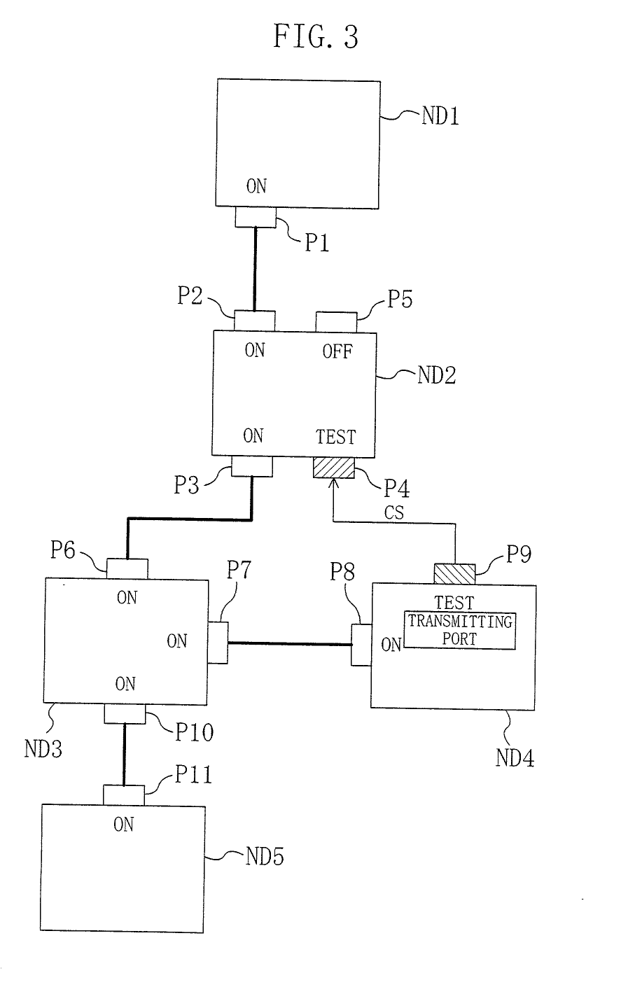

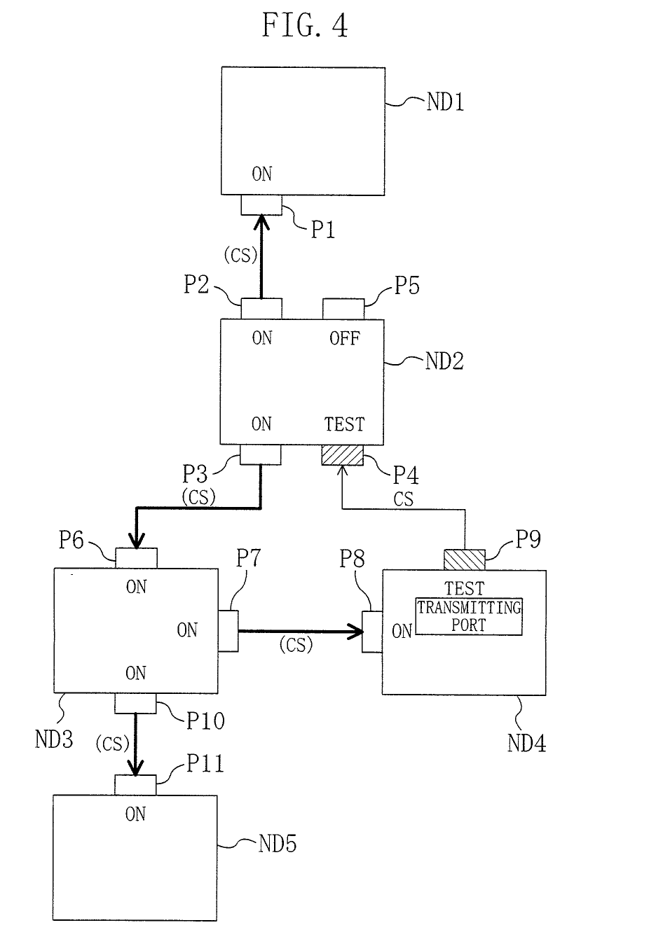

As shown in FIG. 3, the communication node ND4 first transmits a confirmation signal CS from the port P9 (step SA4). Each communication node has a property of propagating the received confirmation signal CS to all the ports in the ON state but the receiving port. In other words, as shown in FIG. 4, the confirmation signal CS is propagated through all the transmission paths on the network, more specifically, the transmission paths P1-P2, P3-P6, P7-P8 and P10-P11.

The communication node ND4 then determines whether or not the confirmation signal CS transmitted from the port P9 returns from another port (in this case, port P8) (steps SA5, SA6). If the confirmation signal CS returns from another port (YES in step SA5), it is then determined in step SA7 that an annular path is formed, and that port is switched to SUSPEND state. If the confirmation signal CS does not return after a sufficient period of time (YES in Step SA6), it is then determined in step SA8 that no annular path is formed, and that port is switched to ON state.

Since the confirmation signal CS herein returns from the port P8, the node ND4 then determines in step SA7 that an annular path is formed by adding the transmission path P4-P9, and the port P9 is switched to SUSPEND state.

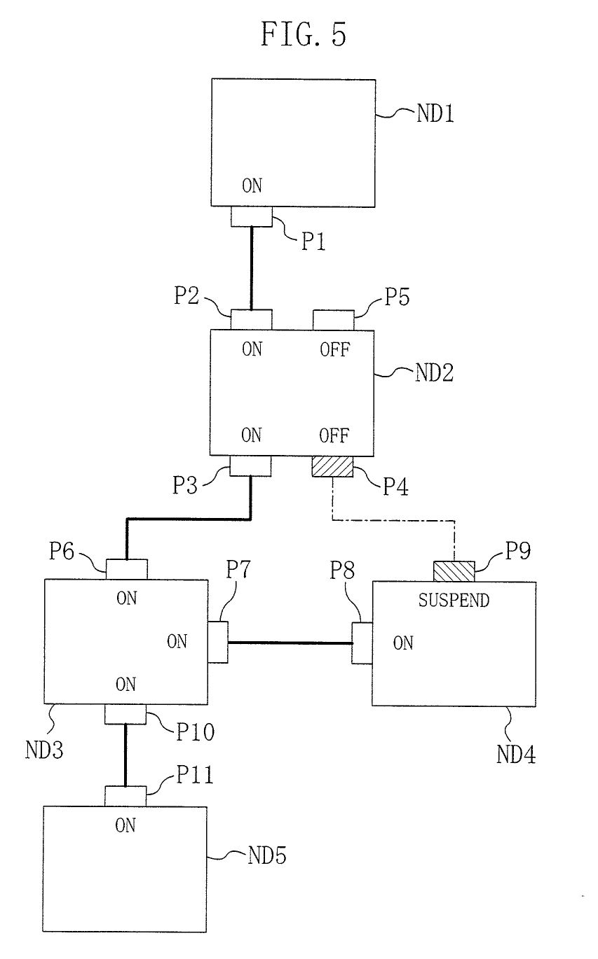

Finally, the condition of step SA10 is determined. Herein, there is no port switched to ON state. Therefore, the processing is terminated (step SA11). More specifically, since the transmission path P4-P9 forms an annular path, adding the transmission path P4-P9 will not result in bus reset. FIG. 5 shows the processing result. Although the ports P4 and P9 are connected through a cable, the port P9 is in SUSPEND state. Therefore, the transmission path P4-P9 is unavailable.

The following methods are possible as a method for switching a port to SUSPEND state: logically switching a port to SUSPEND state by, e.g., changing only an attribute value of the port; and physically switching a port to SUSPEND state by, e.g., rendering the port in high impedance state. The former method would require that the other port of the transmission path (in this case, port P4) be also logically switched to SUSPEND state. In the latter method, the port P4 is automatically switched to OFF state.

This indicates that the processing of switching the port to SUSPEND state when a transmission path is added and the processing of restoring the port to ON state in the future can be conducted easier in the latter method than in the former method. Therefore, it is preferable to use the method for physically switching only one port to SUSPEND state.

Note that, in the present embodiment, the method for determining the parent-child relation between the ports is used to determine a communication node to conduct the confirmation process. However, another method may be used.

Alternatively, both communication nodes located at both ends of the added transmission path may conduct the confirmation process. More specifically, in the example of the present embodiment, both communication nodes ND2 and ND4 may conduct the confirmation process and transmit a confirmation signal.

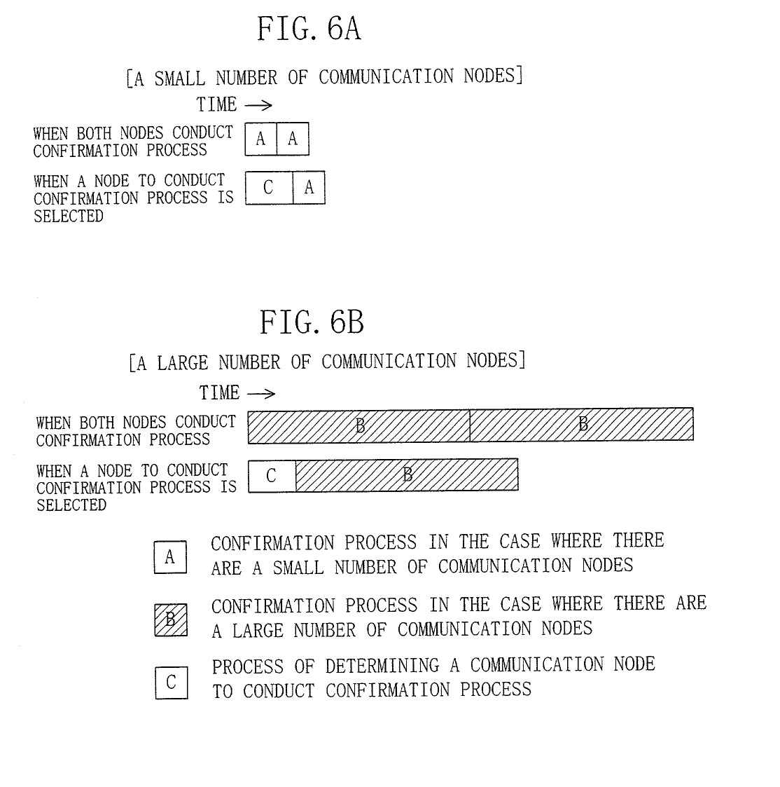

FIGS. 6A and 6B are conceptual diagrams of the time required for the confirmation process. The time required for the confirmation process increases approximately in proportion to increase in the number of communication nodes. Accordingly, as shown in FIG. 6A, in the case where there are a small number of communication nodes, the overall processing time is shorter when both nodes conduct the confirmation process A without conducting the process C of selecting a node to conduct the confirmation process. However, in the case where there are a large number of communication nodes, the overall processing time can be reduced more when the process C of determining a node to conduct the confirmation process is conducted first than when both nodes conduct the confirmation process B.

Note that, in the present embodiment, a communication node for determining whether an annular path is formed or not, i.e., the node ND4, switches the port P9 to SUSPEND state. However, a communication node for determining whether an annular path is formed or not may be different from a communication node for switching a port to SUSPEND state in order to make the added transmission path unavailable. In order to prevent formation of an annular path, a transmission path other than the added transmission path, e.g., the transmission path P3-P6 or P7-P8 may be made unavailable.

(Second Embodiment)

In the second embodiment of the present invention, the process of topology correction will be described in connection with FIG. 2 and FIGS. 7 to 16. It is herein assumed that a plurality of transmission paths are simultaneously added by turning on the power of a communication node.

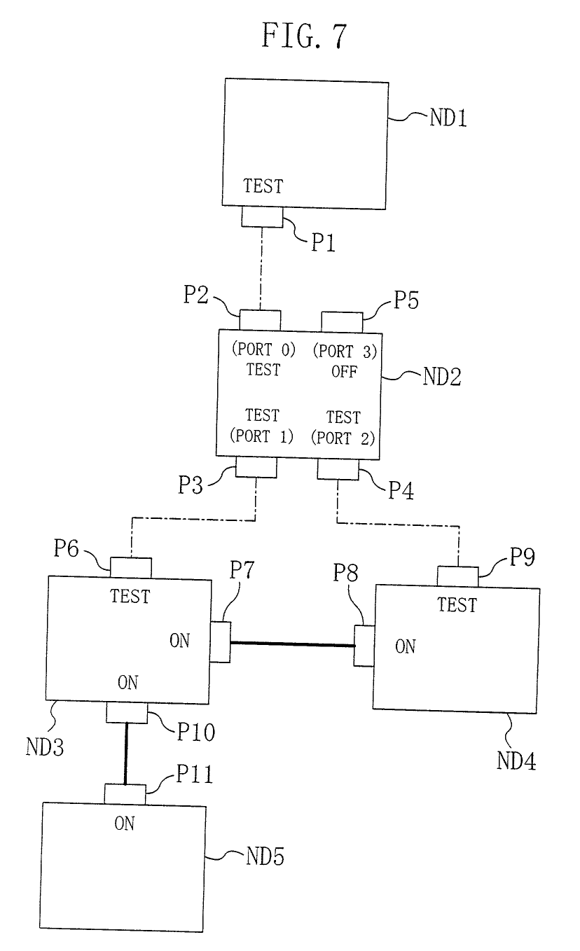

FIG. 7 conceptually shows a network including five communication nodes ND1 to ND5. In FIG. 7, ports P1 and P2, ports P3 and P6, ports P4 and P9, ports P7 and P8, and ports P10 and P11 are connected through a corresponding communication cable. Since the power of the communication node ND2 is off, transmission paths P1-P2, P3-P6 and P4-P9 are in OFF state (shown by chain lines).

The processing in the case where the power of the communication node ND2 is turned on will now be described according to the flow of FIG. 2.

When the power of the communication node ND2 is turned on, four communication nodes ND1 to ND4 sense change in topology resulting from an added transmission path (step SA1).

Then, of the four communication nodes ND1 to ND4, a node to transmit a confirmation signal is determined (step SA2). In the present embodiment, when the power of the communication node is turned on, the powered-on equipment actively serves to transmit a confirmation signal so as to sequentially confirm the added transmission paths.

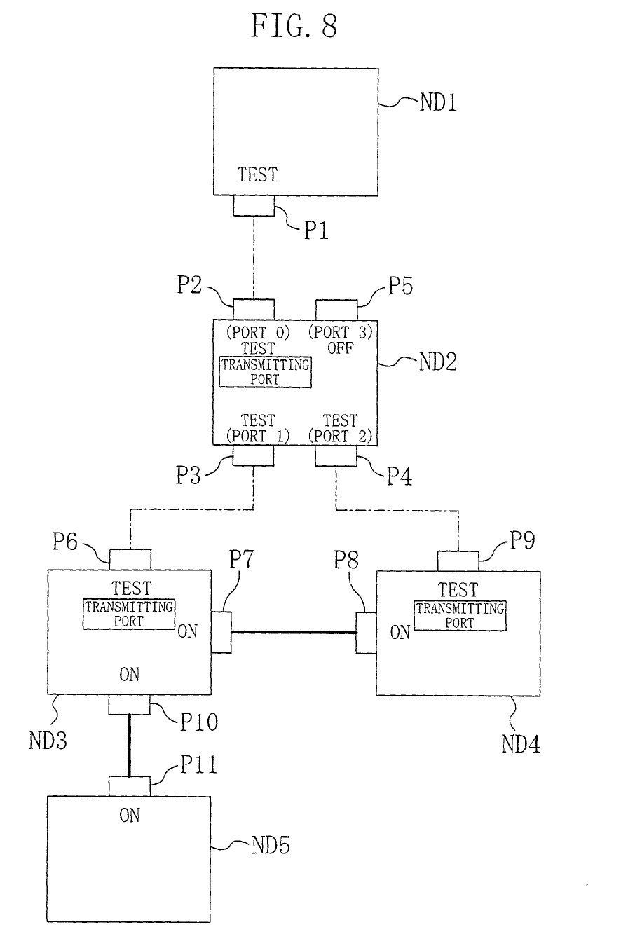

In contrast, when the method for determining the parent-child relation as described in the first embodiment is directly used, a plurality of communication ports may serve as ports to transmit a confirmation signal, as shown in FIG. 8. More specifically, in the example of FIG. 8, the node ND2 transmits a confirmation signal regarding the transmission path P1-P2, the node ND3 transmits a confirmation signal regarding the transmission path P3-P6, and the node ND4 transmits a confirmation signal regarding the transmission path P4-P9.

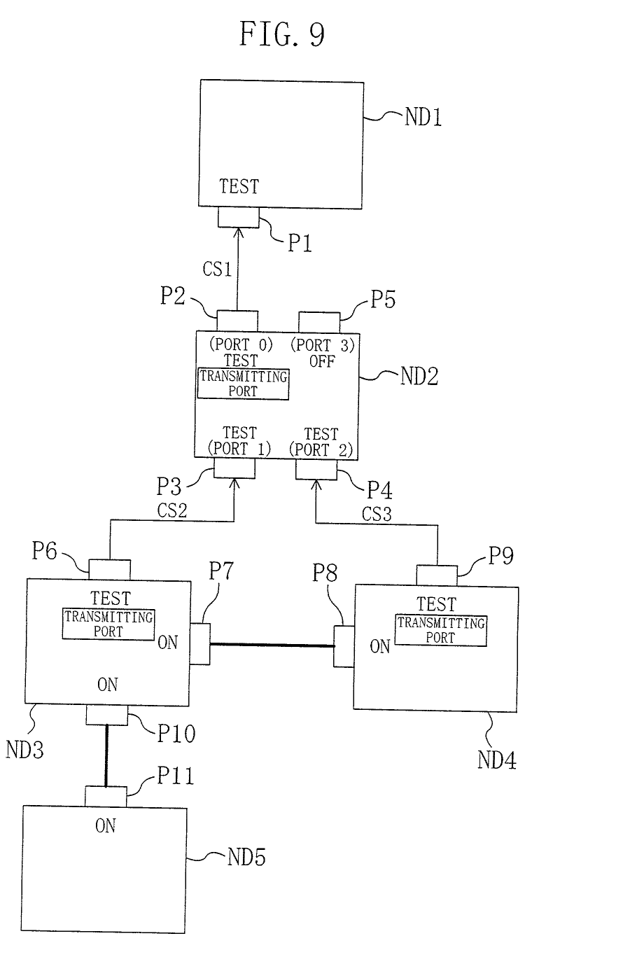

For example, provided that the communication nodes ND2, ND3, ND4 simultaneously conduct the confirmation process without cooperating with each other, confirmation signals CS1, CS2 and CS3 respectively transmitted from the ports P2, P6 and P9 will not return to the original nodes, as shown in FIG. 9. Accordingly, it is determined that no annular path is formed, and all the added transmission paths, that is, the transmission paths P1-P2, P3-P6 and P4-P9, will be rendered in ON state.

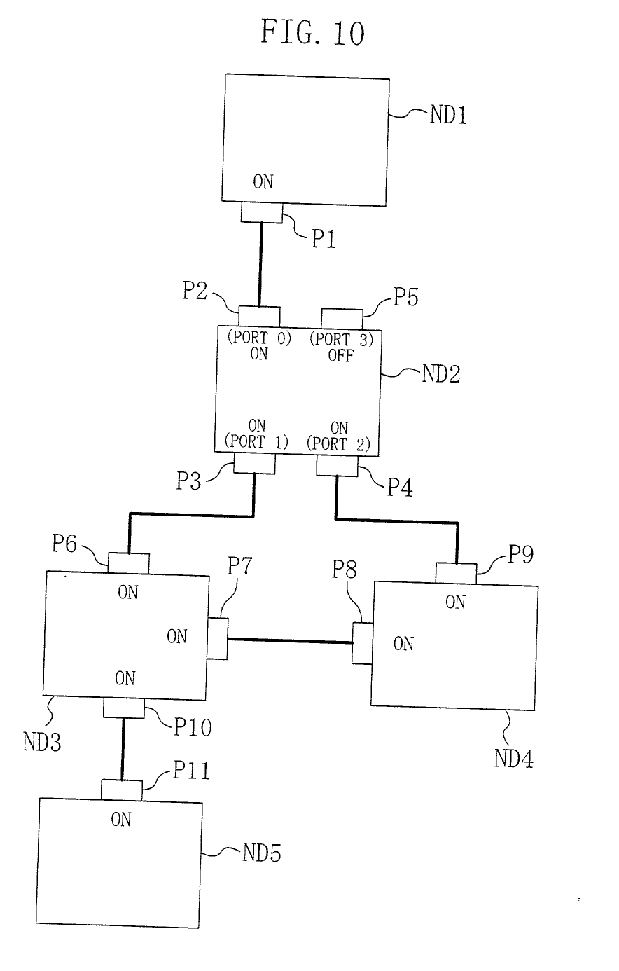

As a result, as shown in FIG. 10, an annular path is formed, so that communication can no longer continue on the network.

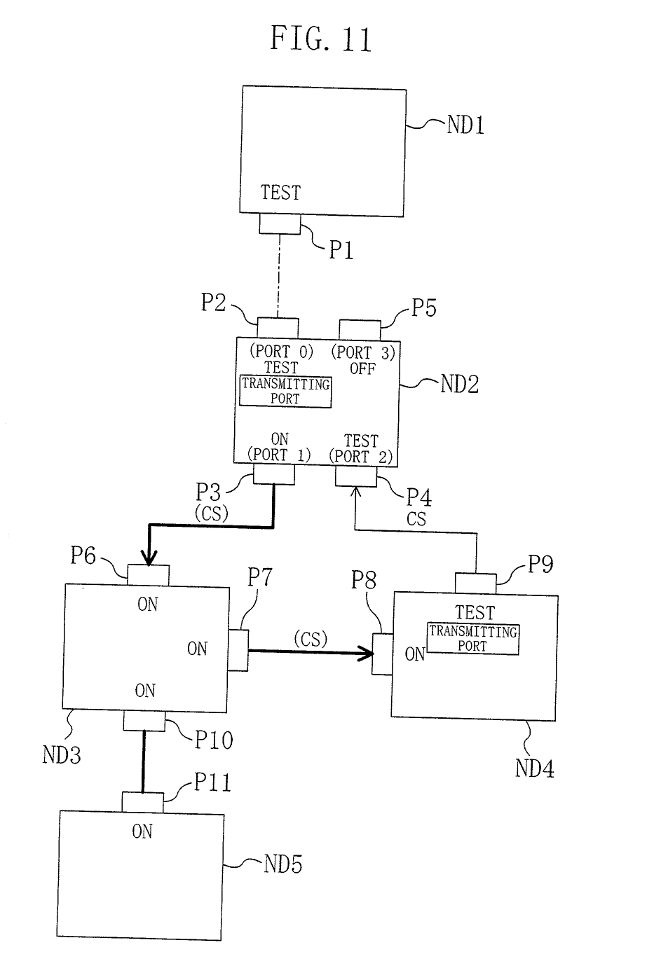

In order to eliminate such a problem resulting from a plurality of equipments serving to transmit a confirmation signal, it is required for the equipments to cooperate with each other so that they do not conduct the processing at the same timing. For example, in the case of FIG. 8, after the communication node ND3 conducts the confirmation process and renders the transmission path P3-P6 in ON state, the communication node ND4 may then conduct the confirmation process. In this case, formation of an annular path can be confirmed as shown in FIG. 11, and therefore the transmission path P4-P9 will not be rendered in ON state.

However, such processing requires cooperation of a plurality of communication nodes.

In the present embodiment, when the power of a communication node is turned on, the powered-on equipment actively serves to transmit a confirmation signal so as to sequentially confirm the added transmission paths. This eliminates the need to consider such complicated cooperation as described above, simplifying the processing.

Note that, a specific determination method in step SA2 is as follows: like the processing in the case where the force root bit defined in IEEE1394 is asserted, transmission of the PARENT_NOTIFY signal is intentionally delayed for the powered-on equipment so that every port in the powered-on equipment serves as a parent port.

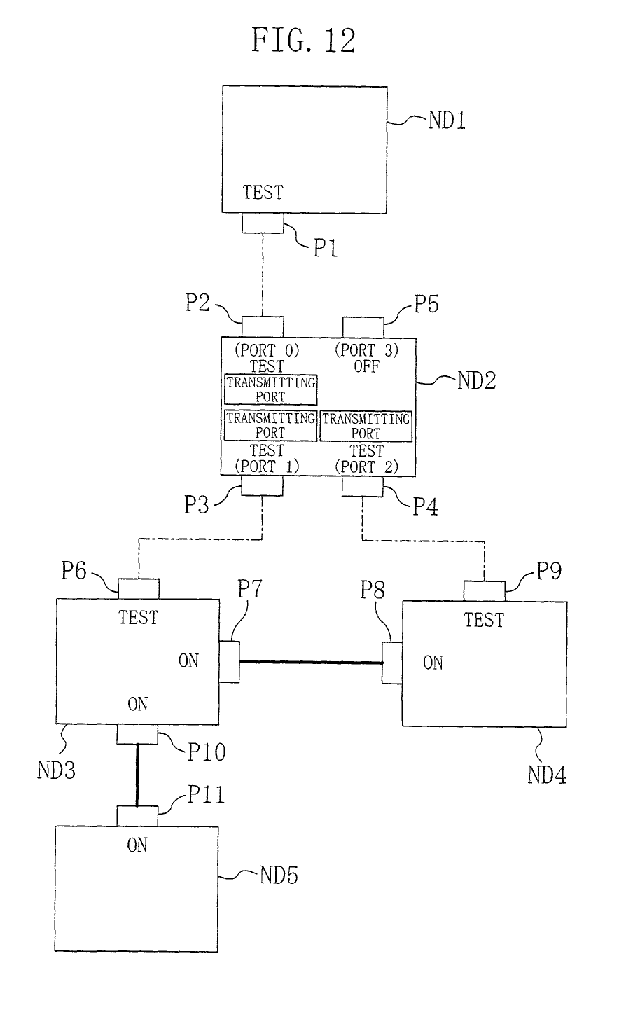

FIG. 12 shows the state in which only the communication node ND2 serves as a node to transmit a confirmation signal as a result of the above processing. The communication node ND2 then conducts the processing of step SA4 and the following steps. The communication nodes other than the node ND2 proceed to step SA11, and terminate the processing.

The processing in step SA4 and the following steps is the same as that of the first embodiment. It should be noted that, in the case where there are a plurality of ports from which a confirmation signal is to be transmitted as in the present embodiment, a confirmation signal is sequentially transmitted from the ports in ascending order of the port number.

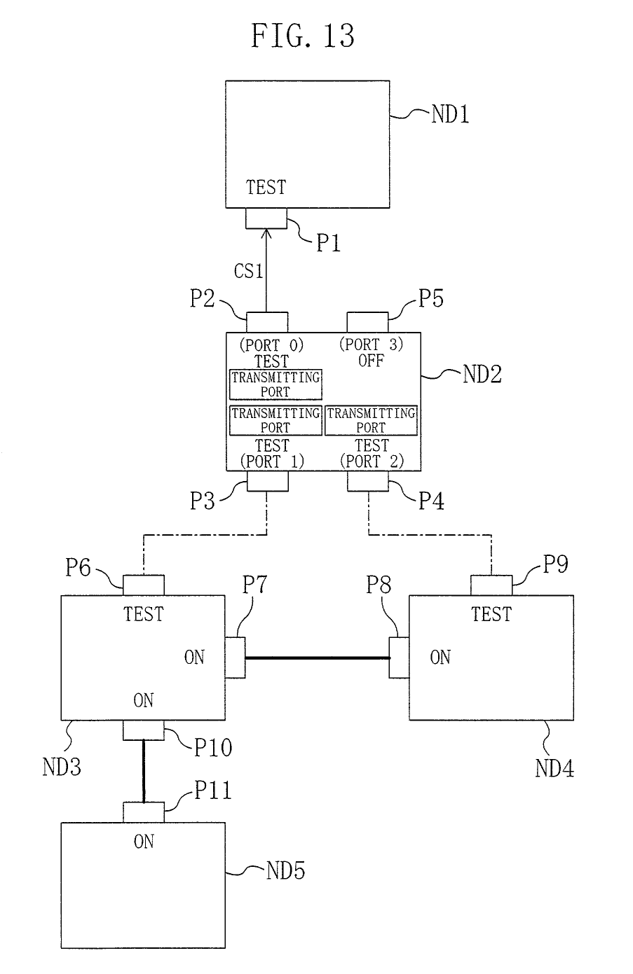

As shown in FIG. 13, a confirmation signal CS1 is first transmitted from the port P2 having port number 0. Since the communication node ND1 does not have any other port in ON state, the confirmation signal CS1 is not propagated any more. Therefore, the condition of step SA6 is satisfied after a sufficient period of time. Step SA8 is then conducted. Since the condition of step SA9 is not satisfied, the flow returns to step SA4.

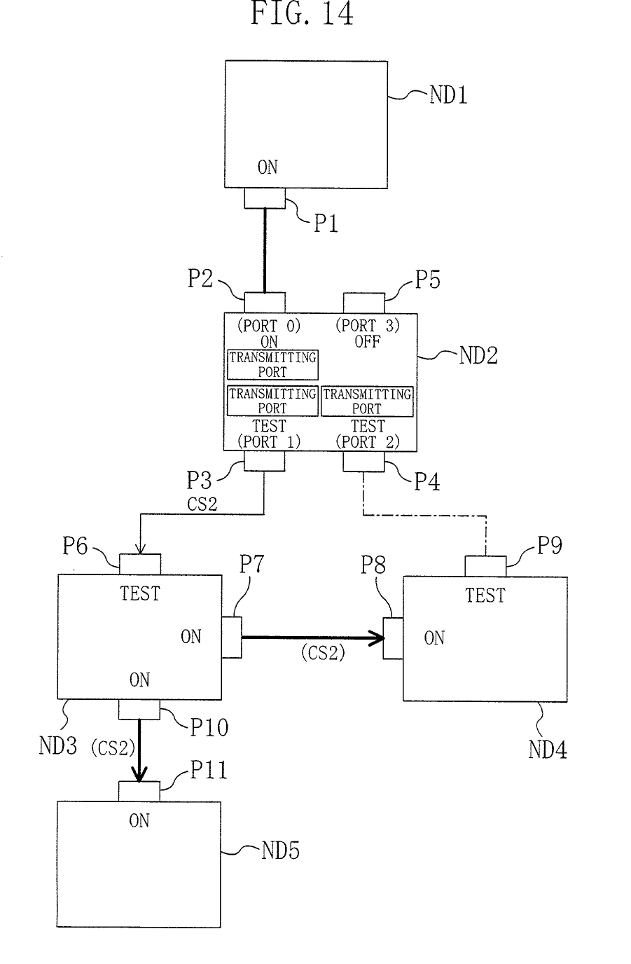

Subsequently, as shown in FIG. 14, a confirmation signal CS2 is transmitted from the port P3 having port number 1. Steps SA5 and SA6 are repeated until the condition of step SAS or SA6 is satisfied. In this case as well, since the condition of step SA6 is satisfied after a sufficient period of time, step SA8 is then conducted. However, the condition of step SA9 is not satisfied, and therefore the flow returns to step SA4.

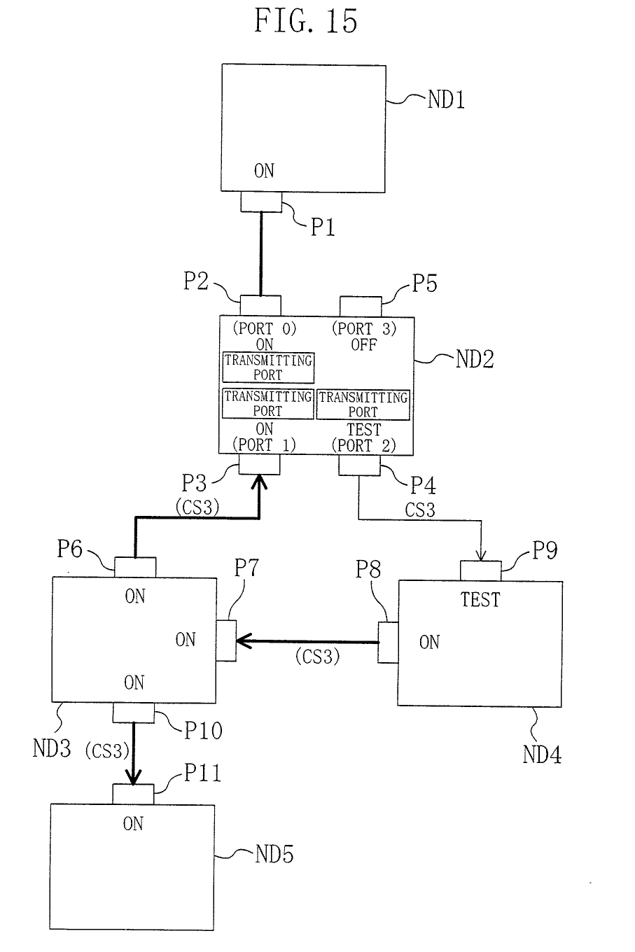

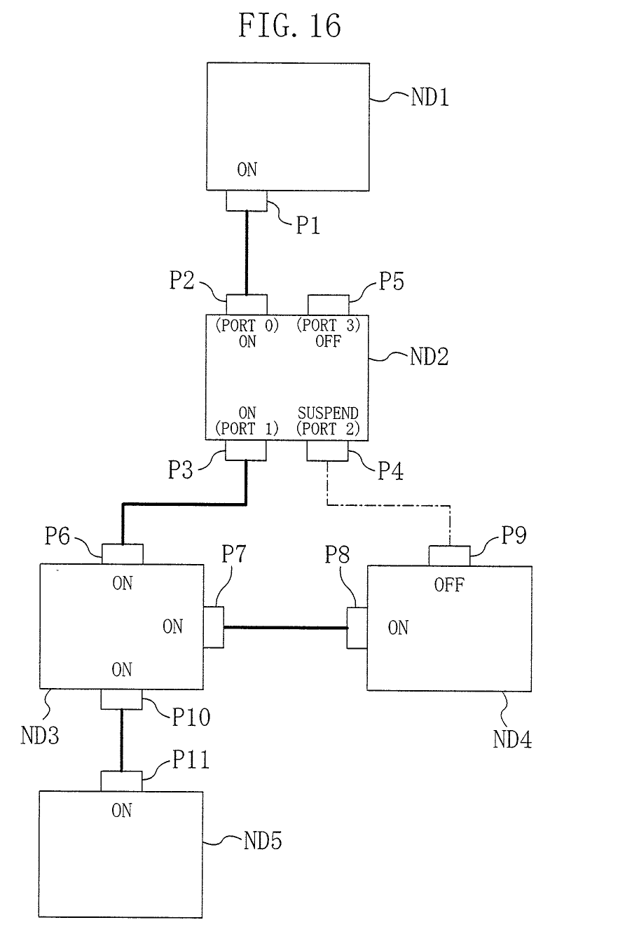

Then, as shown in FIG. 15, a confirmation signal CS3 is transmitted from the port P4 having port number 2. The confirmation signal CS3 passes through the communication nodes ND4, ND3 and then returns to the communication node ND2 from the port P3 having port number 1. Therefore, as shown in FIG. 16, the port P4 is switched to SUSPEND state according to step SA7.

Since the condition of step SA9 is now satisfied and then the condition of step SA10 is satisfied, the flow proceeds to step SA12, where the bus reset is conducted. Subsequently, normal processing is conducted as defined in IEEE1394, whereby the network can be operated successfully.

Note that, in view of the case where the power of a plurality of equipments is simultaneously turned on, it is preferable to preset for each communication node different, unique waiting time calculated from, e.g., its ID. More specifically, a communication node to transmit a confirmation signal transmits a confirmation signal after its preset waiting time. As a result, even when the power of a plurality of equipments is simultaneously turned on, each equipment transmits a confirmation signal at different timing, enabling reliable confirmation of formation of an annular path.

(Third Embodiment)

In the third embodiment of the present invention, the process of topology correction will be described in connection with FIG. 16 and FIGS. 17 to 21. It is herein assumed that a transmission path is disconnected due to failure of a communication cable, power-off of a communication node, or the like.

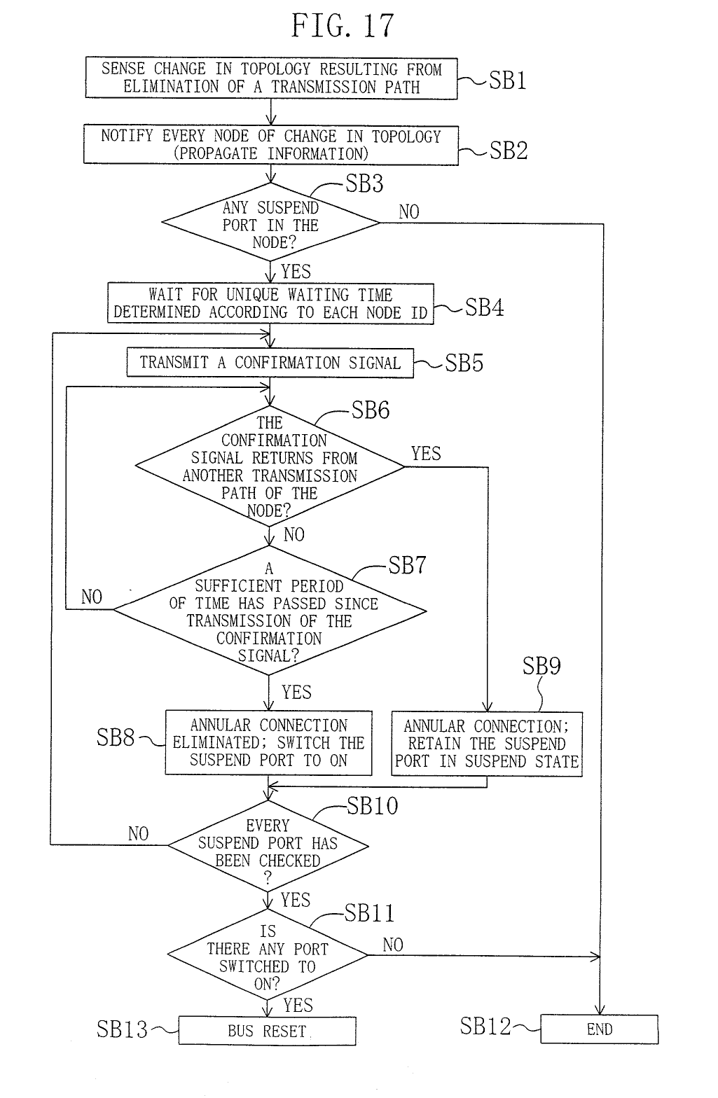

FIG. 17 is a flowchart illustrating the process flow upon sensing a disconnected transmission path. Steps SB4 to SB7 correspond to an annular-path determination process, and step SB8 corresponds to a transmission-path restoration process.

Description will now be given for the topology configuration of FIG. 16. It is herein assumed that a communication cable is removed from the port P10 so as to disconnect the transmission path P10-P11.

In steps SB1 and SB2, each communication node ND1 to ND5 is notified of change in topology. Each communication node ND1 to ND5 then determines whether or not it has any port in SUSPEND state (step SB3). In this case, it is only the communication node ND2 that has a port in SUSPEND state. Therefore, the other communication nodes terminate the processing in step SB12.

The communication node ND2 as a determining node waits for the waiting time determined according to its node ID (step SB4). The reason why each communication node satisfying the condition of step SB3 waits for the unique waiting time determined based on the respective node ID so that each communication node conducts the processing at different timing is as follows: provided that there are a plurality of SUSPEND ports on the network, simultaneously conducting the subsequent processing for the SUSPEND ports may possibly restore an unwanted transmission path and thus an annular path, as in the example shown in the second embodiment. Therefore, conducting the subsequent processing by each communication node after the respective unique waiting time prevents the subsequent processing of each communication node from overlapping each other in terms of time, thereby preventing restoration of an unwanted transmission path.

Note that the waiting time of each communication node is herein determined according to the respective node ID. However, it should be appreciated that the same effects can be obtained by any method for determining the respective waiting time as long as the waiting time ensures that each communication node will not interfere with the subsequent processing of another communication node.

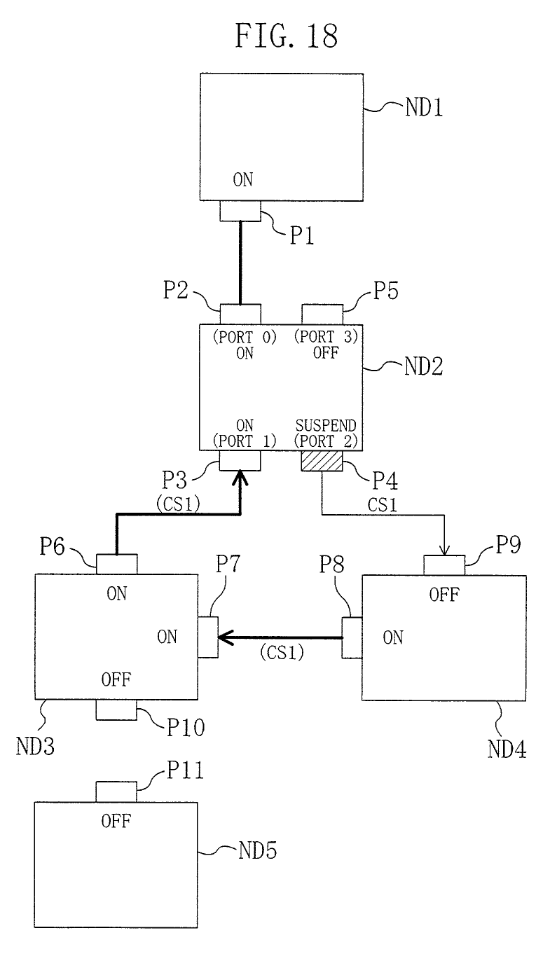

Thereafter, as shown in FIG. 18, the communication node ND2 transmits a confirmation signal CS1 from the port P4 in SUSPEND state. The confirmation signal CS1 thus transmitted from the port P4 is sequentially propagated through the communication nodes ND4, ND3, and then returns to the port P3. In other words, the condition of step SB6 is satisfied, and it is determined in step SB9 that annular connection still exists. Therefore, the port P4 is retained in SUSPEND state.

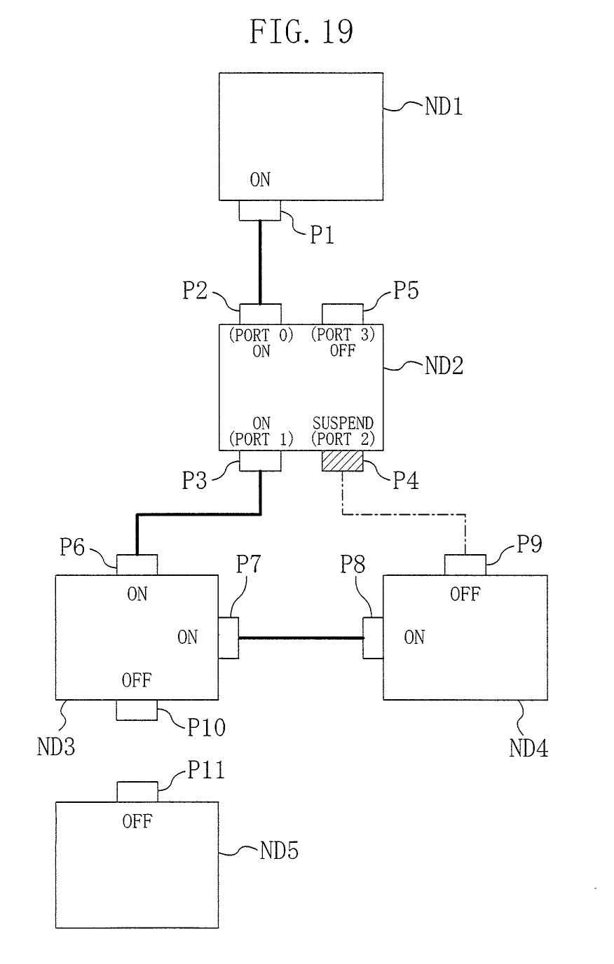

The condition of step SB10 is satisfied, but the condition of step SB11 is not satisfied. Therefore, the processing is terminated in step SB12. As a result, the network is rendered in the state of FIG. 19.

Hereinafter, the processing in the case where the power of the communication path ND3 is shut off in FIG. 19 so that the transmission paths P3-P6 and P7-P8 are disconnected will be described.

Like the above processing, in steps SB1 to SB4, the communication nodes ND1, ND3 to ND5 having no SUSPEND port proceed to step SB12, and the communication node ND2 as a determining node waits for the designated waiting time (step SB4).

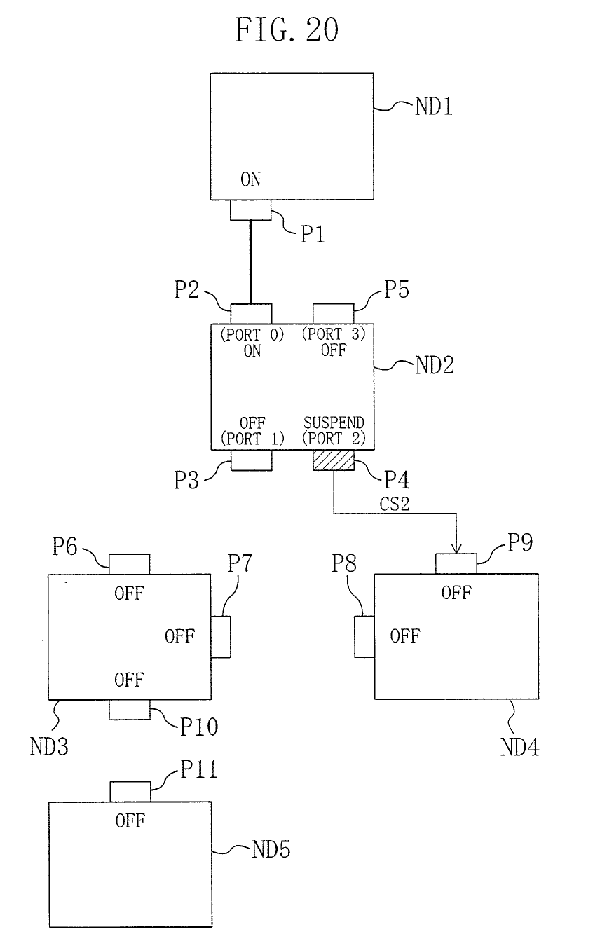

As shown in FIG. 20, the communication node ND2 then transmits a confirmation signal CS2 from the port P4 (step SB5). The confirmation signal CS2 is propagated to the communication node ND4 but will not be propagated any more. As a result, the condition of step SB7 is satisfied. It is therefore determined that no annular path is formed, and the port P4 in SUSPEND state is switched to ON state.

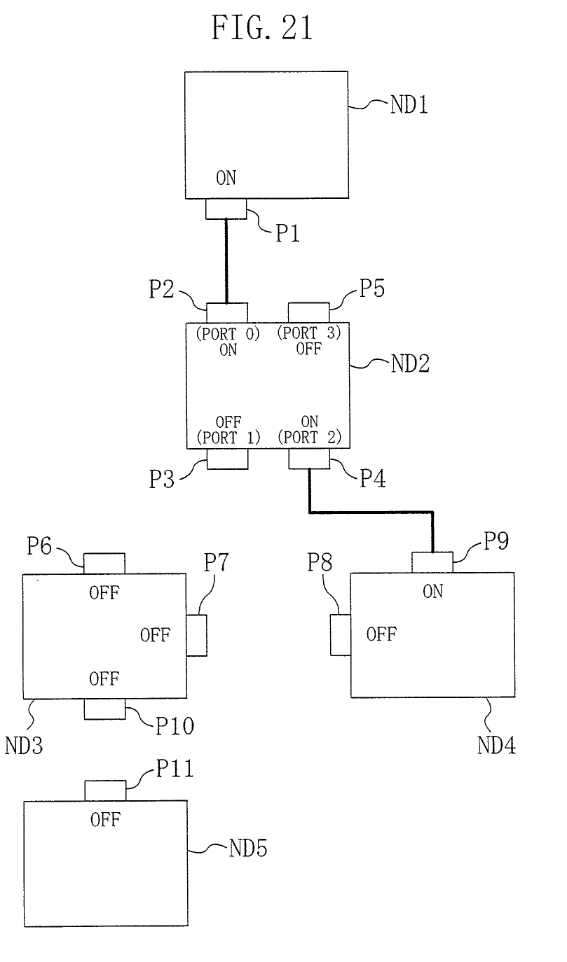

Since the conditions of steps SB10 and SB11 are both satisfied, bus reset is conducted in step SB3. As a result, as shown in FIG. 21, the transmission path P4-P9 is restored, and the port P9 is rendered in ON state.

Note that the above embodiments have been described for the network as defined in IEEE1394. However, it should be appreciated that the present invention is readily applicable to another network.

As has been described above, according to the present invention, when a new transmission path is added, at least one of the communication nodes located at both ends of the added transmission path determines whether or not a new annular path is formed by the added transmission path. If it is determined that a new annular path is formed, that transmission path is logically or physically made unavailable in order to prevent formation of the annular path.

According to the present invention, when an arbitrary transmission path is eliminated, at least one of the communication nodes located at both ends of an unavailable transmission path determines whether or not an annular path is formed if the unavailable transmission path becomes available. If it is determined that no annular path is formed, the unavailable transmission path is made available.

As a result, even an interface that is incapable of communication when the communication nodes are connected in an annular manner can continue communication even after annular connection, and also continue communication by using the maximum available transmission paths.

What is claimed is:

1. A method for correcting topology in a network including a plurality of communication nodes, comprising:
an annular-path determination process in which, when a new transmission path is added, at least one of communication nodes located at both ends of the added transmission path determines as a determining node whether or not a new annular path is formed by the added transmission path; and
a transmission-path disconnection process in which, when it is determined in the annular-path determination process that a new annular path is formed, at least one of the communication nodes located at both ends of the added transmission path logically or physically makes the added transmission path unavailable in order to prevent formation of the annular path.

2. The method according to claim 1, wherein the determining node is one of the communication nodes located at both ends of the added transmission path.

3. The method according to claim 1, wherein when a new transmission path is added by turning on power of a single communication node, only the powered-on communication node serves as the determining node in the annular-path determination process.

4. The method according to claim 1, wherein in the annular-path determination process, the determining node transmits a confirmation signal through the added transmission path, and determines whether or not a new annular path is formed by determining whether or not the confirmation signal returns from a transmission path of the determining node other than the added transmission path.

5. The method according to claim 4, wherein the communication nodes have preset, unique waiting times different from each other, and in the annular-path determination process, the determining node transmits the confirmation signal after the corresponding preset waiting time.

6. The method according to claim 1, wherein the transmission-path disconnection process includes the step of logically or physically making an attribute of a port forming the added transmission path unavailable by one of the communication nodes located at both ends of the added transmission path.

7. A method for correcting topology in a network including a plurality of communication nodes, comprising:
an annular-path determination process in which, when an arbitrary transmission path is eliminated, at least one of communication nodes located at both ends of a logically or physically unavailable transmission path determines as a determining node whether or not an annular path is formed if the unavailable transmission path becomes available; and
a transmission-path restoration process in which, when it is determined in the annular-path determination process that no annular path is formed, at least one of the communication nodes located at both ends of the unavailable transmission path makes the unavailable transmission path available.

8. The method according to claim 7, wherein in the annular-path determination process, the determining node transmits a confirmation signal through the unavailable transmission path, and determines whether or not an annular path is formed by determining whether or not the confirmation signal returns from a transmission path of the determining node other than the unavailable transmission path.

9. The method according to claim 8, wherein the communication nodes have preset, unique waiting times different from each other, and in the annular-path determination process, the determining node transmits the confirmation signal after the corresponding preset waiting time.

10. A communication node forming a network, wherein when a new transmission path is added to a port of the communication node, the communication node transmits a confirmation signal through the added transmission path, and determines whether or not a new annular path is formed in the network by determining whether or not the confirmation signal returns from a transmission path of the communication node other than the added transmission path.

11. A communication node forming a network, wherein when an arbitrary transmission path in the network is eliminated and a port of the communication node is connected to a logically or physically unavailable transmission path, the communication node transmits a confirmation signal through the unavailable transmission path, and determines whether or not an annular path is formed if the unavailable transmission path becomes available by determining whether or not the confirmation signal returns from a transmission path of the communication node other than the unavailable transmission path.
